(19) United States
(12) Patent Application Publication
(10) Pub. No.: US 2025/0100274 A1
(43) Pub. Date: Mar. 27, 2025

(54) PRINTING METHOD AND ROBOT SYSTEM

(71) Applicant: SEIKO EPSON CORPORATION, Tokyo (JP)

(72) Inventor: Tomohisa IWAZAKI, Shimosuma-Machi (JP)

(21) Appl. No.: 18/890,811

(22) Filed: Sep. 20, 2024

(30) Foreign Application Priority Data
Sep. 22, 2023 (JP) 2023-158087

(51) Int. Cl. B41J 2/045; B25J 11/00; B41J 2/21; B41J 25/00; B41M 5/00

(52) U.S. Cl. CPC B41J 2/04573; B25J 11/0075; B41J 2/04556; B41J 2/2103; B41J 25/001; B41M 5/0088; B41J 2/04581

(57) ABSTRACT

A printing method includes performing printing operation on an object by ejecting ink from a nozzle while relatively moving the object and the print head along a printing trajectory by using a robot including the print head in which a plurality of nozzles are disposed, wherein controlling a timing of ejecting the ink from the nozzle or the ejection speed of the ink based on a separation distance between the nozzle and the object.

### CROSS-REFERENCE TO RELATED APPLICATIONS

The present application is based on, and claims priority from JP Application Serial Number 2023-158087, filed Sep. 22, 2023, the disclosure of which is hereby incorporated by reference herein in its entirety.

### BACKGROUND OF THE INVENTION

### 1. Technical Field

The present disclosure relates to a printing method and a robot system.

### 2. Related Art

The printing system described in JP-A-2013-202781 prints on an object by ejecting ink from a print head toward the object while moving a robot provided with a print head mounted on the tip thereof along a print trajectory. The printing system also includes a rotation angle sensor for detecting the actual position of the print head, and a piezo actuator disposed between it and the print head to correct the position of the print head based on the actual position of the print head. Then, by correcting the position of the print head based on the actual position of the print head, printing without strips (gaps) is realized.

However, in the printing system of JP-A-2013-202781, when printing is performed on a non-planar printing surface such as a curved surface or a bent surface, then ink ejection distances at various sections, that is, separation distances between the print head and the printing surface, vary. As a result, this leads to a deterioration of the print quality due to printing misalignment, blurring, and the like.

### SUMMARY OF THE INVENTION

The printing method of the present disclosure includes, performing a printing operation on an object by ejecting ink from nozzles while relatively moving the object and the print head along a printing trajectory by using a robot equipped with the print head in which the plurality of nozzles are disposed, wherein controlling a timing of ejecting the ink from the nozzle or an ejection speed of the ink based on a separation distance between the nozzle and the object.

The robot system of the present disclosure includes, a robot including a print head in which a plurality of nozzles are disposed; a control device configured to control driving of the robot, wherein the control device performs a printing operation on an object by ejecting ink from the nozzle while relatively moving the object and the print head along a printing trajectory, and in the printing operation, a timing of ejecting ink from the nozzle or an ejection speed of the ink is controlled based on a separation distance between the nozzle and the object.

### BRIEF DESCRIPTION OF DRAWINGS

FIG. 1 is an overall view of a robot system according to the first embodiment.

FIG. 2 is a plan view showing a distal end surface of the print head provided in the robot shown in FIG. 1.

FIG. 3 is a plan view showing a moving stage provided in the robot shown in FIG. 1.

FIG. 4 is a flowchart for explaining a printing method.

FIG. 5 is a view showing a state of a printing operation.

FIG. 6 is a diagram showing an example of a print image.

FIG. 7 is a time chart showing an example of an ink ejection timing.

FIG. 8 is a view showing a state of a printing operation.

FIG. 9 is view for explaining the problems of the conventional printing method.

FIG. 10 is a view for explaining the problems of the conventional printing method.

FIG. 11 is a view for explaining the problems of the conventional printing method.

FIG. 12 is a view for explaining the problems of the conventional printing method.

FIG. 13 is a view for explaining the problems of the conventional printing method.

FIG. 14 is a view for explaining the problem of the conventional printing method.

FIG. 15 is a view showing an example of a GUI.

FIG. 16 is a graph showing a relationship between the shape of an object and the displacement of the ink landing position.

FIG. 17 is a time chart corrected based on the relationship shown in FIG. 16.

FIG. 18 is a graph showing a relationship between the shape of an object and the displacement of the ink landing position.

FIG. 19 is a time chart corrected based on the relationship shown in FIG. 18.

FIG. 20 is a time chart showing the ink ejection timing after correction.

FIG. 21 is a view showing a modified example of an object.

FIG. 22 is a view showing a modified example of an object.

FIG. 23 is a view showing a modified example of an object.

FIG. 24 is a diagram showing a configuration of a distal end portion of a robot included in the robot system according to the third embodiment.

### DETAILED DESCRIPTION OF THE INVENTION

Hereinafter, a printing method and a robot system of the present disclosure will be described in detail based on embodiments shown in the accompanying drawings.

### First Embodiment

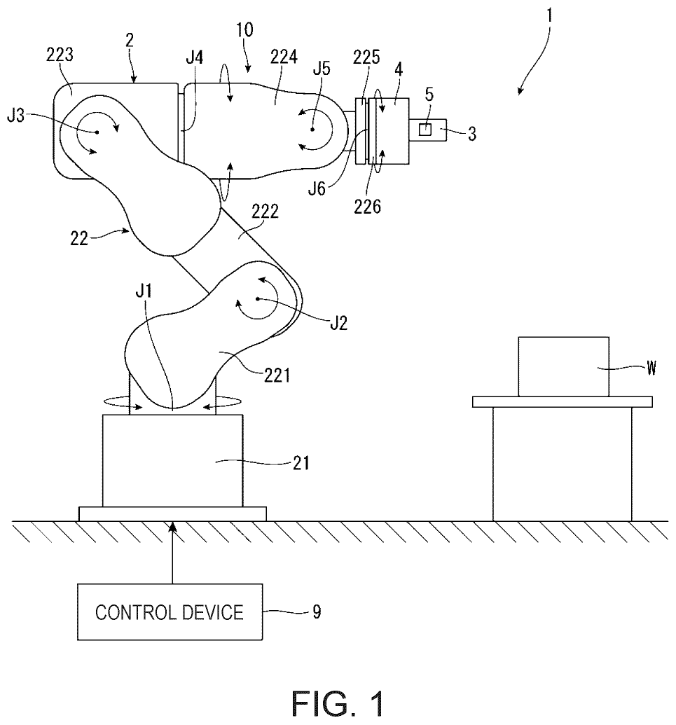

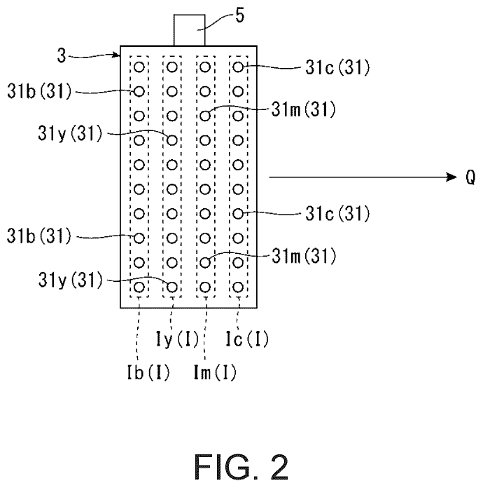

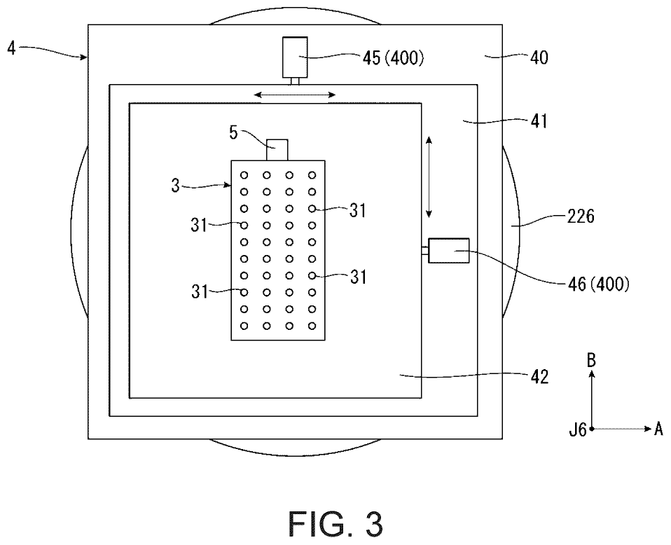

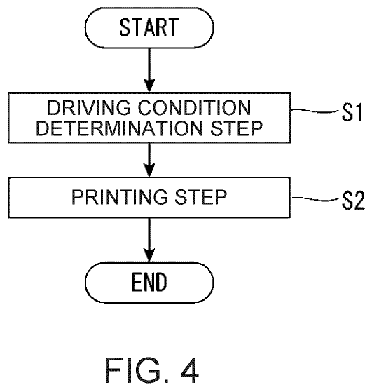

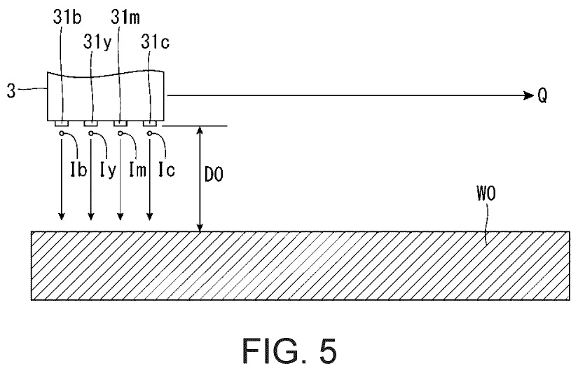

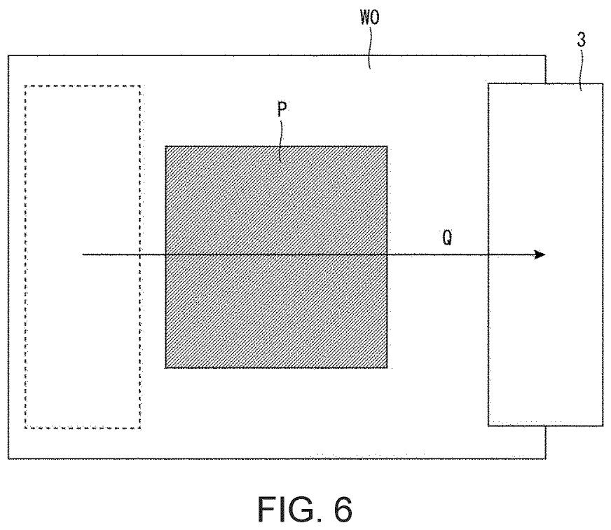

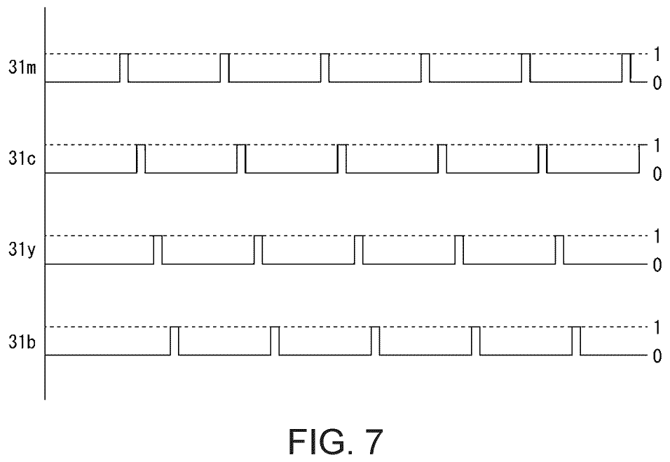

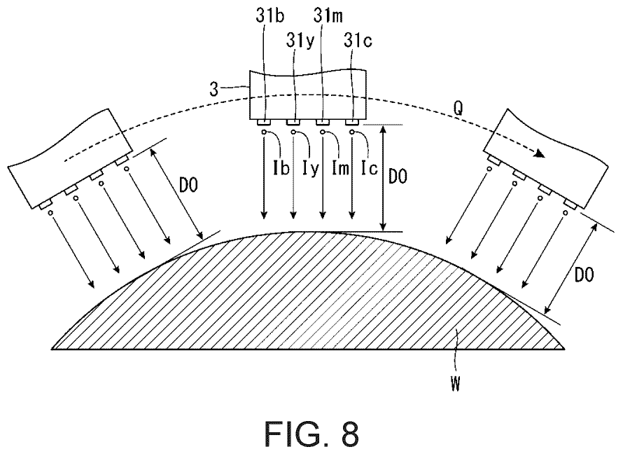

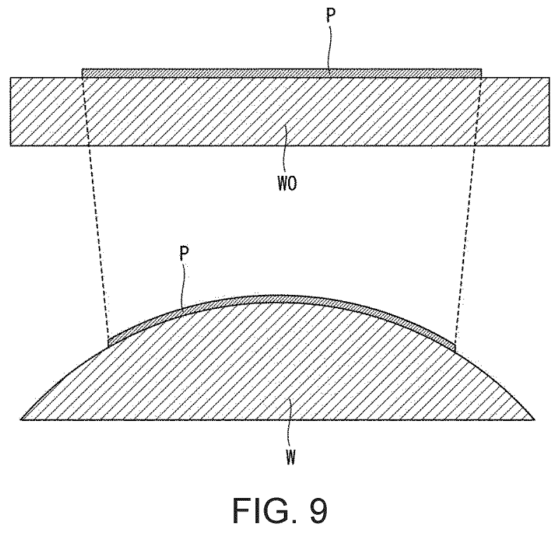

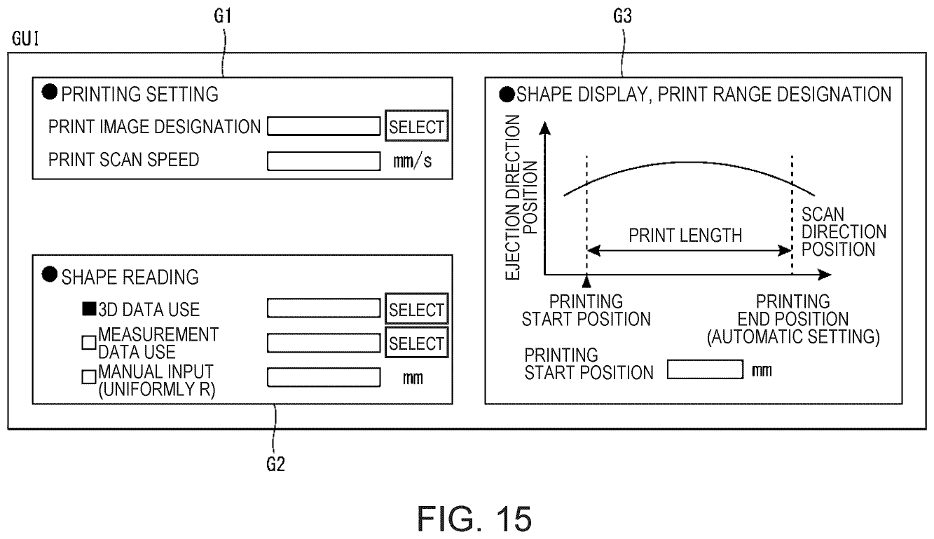

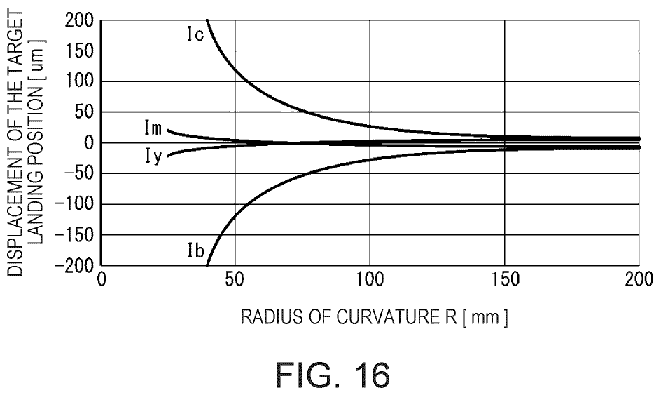

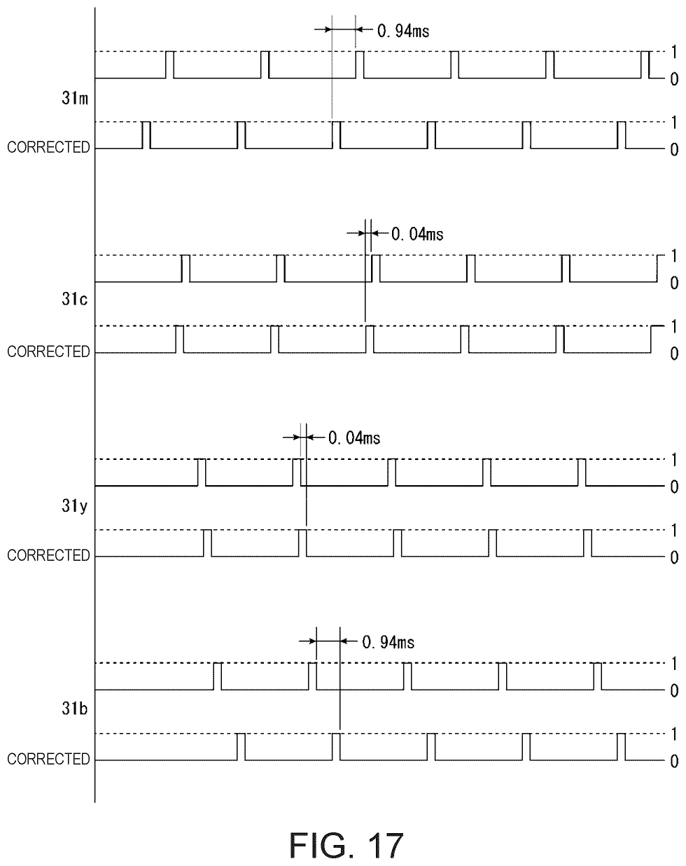

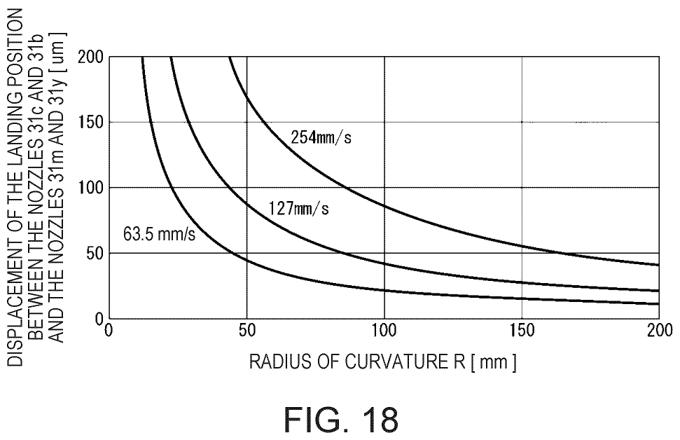

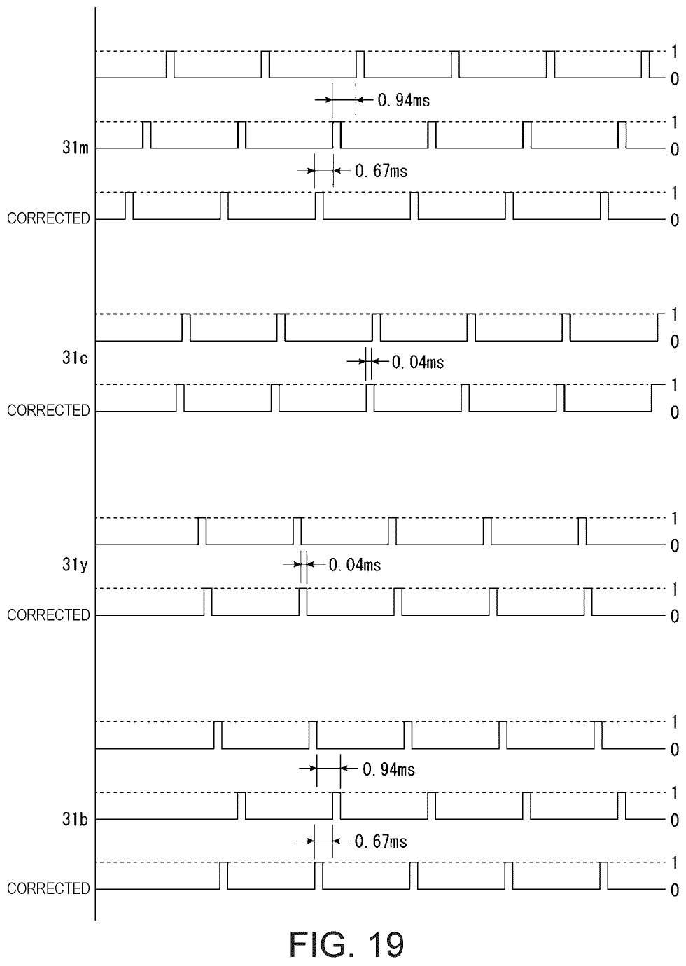

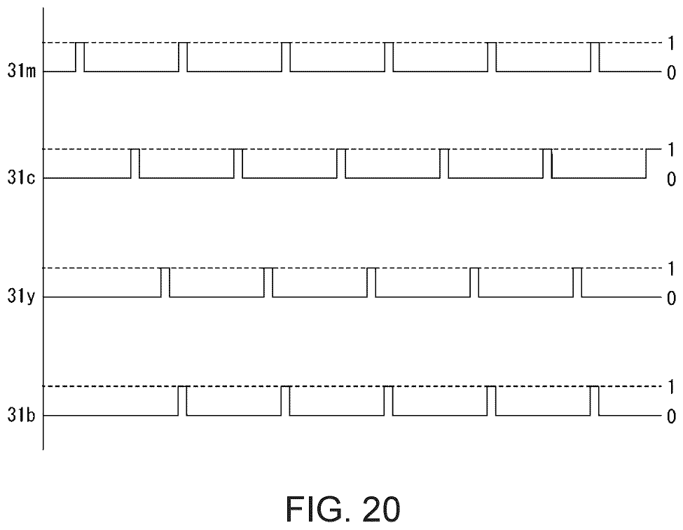

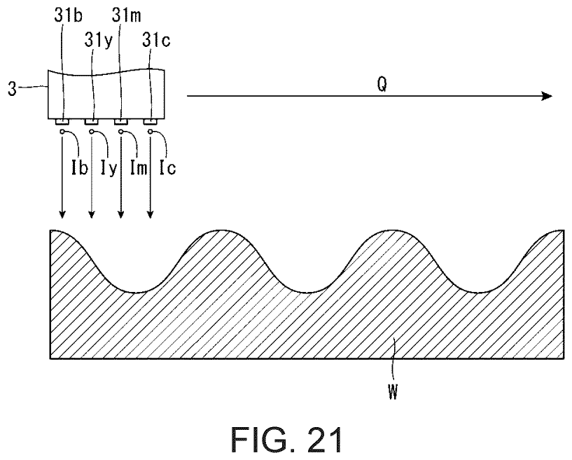

FIG. 1 is an overall view of a robot system according to the first embodiment. FIG. 2 is a plan view showing a distal end surface of a print head provided in the robot shown in FIG. 1. FIG. 3 is a plan view showing a moving stage provided in the robot shown in FIG. 1 FIG. 4 is a flowchart for explaining a printing method. FIG. 5 is a view showing a state of a printing operation. FIG. 6 is a diagram showing an example of a print image. FIG. 7 is a time chart showing an example of an ink ejection timing. FIG. 8 is a view showing a state of a printing operation. FIGS. 9 to 14 are shows for explaining the problems of the conventional printing method. FIG. 15 is a view showing an example of a GUI. FIG. 16 is a graph showing a relationship between the shape of an object and the displacement of the ink landing position. FIG. 17 is a time chart corrected based on the relationship shown in FIG. 16. FIG. 18 is a graph showing a relationship between the shape of an object and the displacement of the ink landing position. FIG. 19 is a time chart corrected based on the relationship shown in FIG. 18. FIG. 20 is a time chart showing the ink ejection timing after correction. FIGS. 21 to 23 are views showing a modified example of an object.

The robot system 1 shown in FIG. 1 is applied to a printing system for performing a printing operation on an object W. The robot system 1 includes a robot 10 and a control device 9 for controlling driving of the robot 10. The robot 10 includes a robot main body 2, a print head 3 attached to the distal end of the robot main body 2, a moving stage 4 disposed between the robot main body 2 and the print head 3, and a vibration meter 5 disposed on the print head 3.

### Robot Main Body 2

The robot main body 2 is a six axes vertical articulated robot having six drive shafts, and includes a base 21 fixed to a mounting table, floor, and the like, and a robot arm 22 pivotably connected to the base 21. The robot arm 22 has a configuration in which six arms 221, 222, 223, 224, 225, and 226 are pivotably connected in this order from the base 21 side, and includes six joints J1, J2, J3, J4, J5, and J6. Among these joints J1 to J6, joints J2, J3, and J5 are bending joints, and joints J1, J4, and J6 are torsional joints. Each of the joints J1, J2, J3, J4, J5, and J6 is provided with a drive mechanism including a motor as a drive source and an encoder that detects the amount of rotation of the joint. By independently moving the joints J1, J2, J3, J4, J5, and J6, the print head 3 attached to the distal end of the robot arm 22 can be moved in a desired direction in a desired posture.

However, the configuration of the robot main body 2 is not particularly limited. For example, the number of arms provided in the robot arm 22 is not limited to six. The robot main body 2 may be a dual-arm robot, a horizontal multi-articulation robot (SCARA robot), and the like. The robot main body 2 may not be fixed to a mounting table, a floor, and the like, and may be self-propelled.

### Print Head 3

The print head 3 is disposed at the distal end of the robot arm 22, that is, on the arm 226. The print head 3 is not particularly limited, but the ink jet head of the piezo drive system is used in the present embodiment. The ink jet head of the piezo drive system has an ink chamber, a diaphragm constituting a part of a wall surface of the ink chamber, a piezo element vibrating the diaphragm, and a nozzle connected to the ink chamber. When a voltage is applied to the piezo element to vibrate the piezo element, the diaphragm vibrates and the ink I in the ink chamber is ejected from the nozzle.

In particular, the print head 3 of the present embodiment is configured to perform full-color printing of a CMYK color model. As shown in FIG. 2, the print head 3 has nozzles 31c for ejecting the cyan ink Ic, nozzles 31m for ejecting the magenta ink Im, nozzles 31y for ejecting the yellow ink Iy, and nozzles 31b for ejecting the black ink Ib. In the present embodiment, the print head 3 is controlled to move with respect to the object W along a printing trajectory Q indicated by an arrow, and the nozzles 31c, 31m, 31y, and 31b are aligned along the printing trajectory Q. The nozzles 31c, 31m, 31y, and 31b are aligned in a direction perpendicular to the printing trajectory Q. Also, printing is performed by ejecting the ink I from each nozzle 31 of the print head 3 at a predetermined timing and depositing the ink I on the object W while moving the print head 3 along the printing trajectory Q.

However, the arrangement of the plurality of nozzles 31, the color of the ink I ejected from each of the nozzles 31, and the like are not particularly limited. For example, the configuration may be such that black ink Ib is ejected from all of the nozzles 31. The configuration of the print head 3 is not limited to an ink jet head with the piezo drive system described above. For example, the ink jet head may be of a thermal type that utilizes a film boiling phenomenon of the ink I, a bubble discharge type that ejects the ink I by generating bubbles in the ink I by applying heat, or an electrostatic actuator type that ejects the ink I by displacing and vibrating the diaphragm by an electrostatic force.

### Moving Stage 4

As shown in FIG. 1, the moving stage 4 is disposed between the arm 226 and the print head 3. Such a moving stage 4 is used to correct the position of the print head 3. As shown in FIG. 3, the moving stage 4 includes a base 40 supported by the arm 226, a first stage 41 which linearly moves in a first direction A with respect to the base 40, and a second stage 42 which linearly moves in a second direction B perpendicular to the first direction A with respect to the first stage 41. The print head 3 is disposed on the second stage 42.

The moving stage 4 includes a first stage driving section 45 that moves the first stage 41 in the first direction A with respect to the base 40, and a second stage driving section 46 that moves the second stage 42 in the second direction B with respect to the first stage 41. Each of the first and second stage drive sections 45 and 46 is included with piezoelectric actuator 400 driven by using the expansion and contraction of piezoelectric elements due to energization, and the vibration of the piezoelectric actuators 400 is transmitted to the first stage 41 and the second stage 42 to move them. As described above, by using the piezoelectric actuator 400, it is possible to minutely and highly accurately control the movement amount and the movement speed of the first and second stages 41 and 42, and it is also possible to quickly switch the movement direction. Therefore, it is possible to accurately correct the position of the print head 3. It is also possible to reduce the size and weight of the moving stage 4. Therefore, it is possible to suppress as much as possible an increase in the weight of the distal end of the robot main body 2 caused by the arrangement of the moving stage 4, and it is possible to effectively suppress a decrease in the drive characteristics such as the responsiveness and the damping property of the robot main body 2.

However, the configuration of moving stage 4 is not particularly limited. For example, the first and second stage drive sections 45 and 46 may be configured to use a driving source other than the piezoelectric actuator 400, such as a motor that rotates by energization. The moving stage 4 may be omitted. In this case, the position of the print head 3 may be corrected by the robot arm 22.

### Vibration Meter 5

As shown in FIG. 1, the vibration meter 5 is disposed on the print head 3 and detects the vibration of the print head 3. “Vibration” means displacement of the print head 3 other than displacement along the printing trajectory Q (to be described later). The vibration meter 5 is, for example, a three-axis angular velocity sensor for detecting angular velocities in three orthogonal axis directions each other.

### Control Device 9

As shown in FIG. 1, the control device 9 is electrically connected to the robot 10 and controls drive of the robot 10. Specifically, the control device 9 controls the drive of the robot main body 2, the print head 3, the moving stage 4, and the vibration meter 5 independently or in conjunction with each other. The control device 9 is formed of, for example, a computer, and includes a processor (CPU) that processes information, a memory that is communicably connected to the processor, and an external interface that is connected to an external device. Various programs executable by the processor are stored in the memory, and the processor can read and execute the programs stored in the memory.

The configuration of the robot system 1 has been described above. Next, a printing method using the robot system 1 will be described. As shown in FIG. 4, the printing method includes a driving condition determination step S1 in which driving conditions of the print head 3 are determined in advance, and a printing step S2 in which printing is performed on the object W by driving the print head 3 based on the driving conditions determined in the driving condition determination step S1. The shape of the object W, more specifically, the shape of the surface to be printed of the object W is not particularly limited, but is preferably a non-flat surface such as a curved surface, a bent surface, or a surface obtained by combining these surfaces, that is, a three dimensional shape other than a flat surface. By this, the effect of the printing method of the present embodiment becomes remarkable. Hereinafter, each of these steps S1 and S2 will be described in detail, but prior to that, features of the printing method of the present embodiment will be briefly described.

Here, as an example, FIG. 7 shows the ink ejection timing for printing the quadrangle P shown in FIG. 6 by, as shown in FIG. 5, ejecting the ink I while moving the print head 3 at a constant speed along the printing trajectory Q that maintains the ideal distance D0 with respect to the planar object W0. In FIG. 7, it means that the ink I is ejected from each of the nozzles 31c, 31m, 31y, and 31b at the timing of “1”

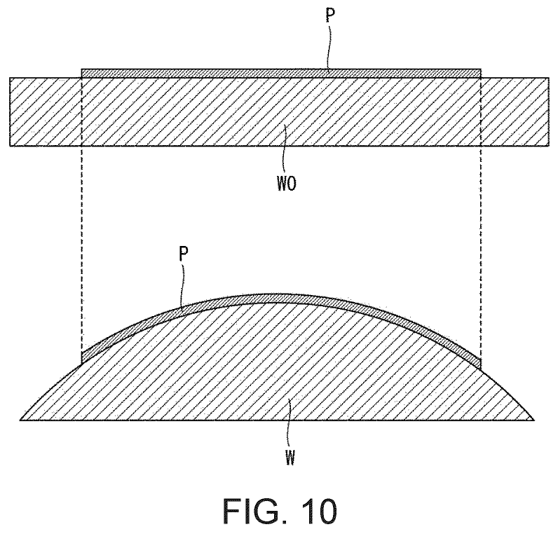

On the other hand, FIG. 8 shows a state in which printing is performed by ejecting the ink I while moving the print head 3 at a constant speed along the printing trajectory Q which maintains the ideal distance D0 with respect to the object W which is an arc-shaped curved surface. Here, when the same quadrangle as that in FIG. 6 is printed on the object W of the curved surface, as shown in FIG. 9, the planar quadrangle P needs to be printed while being curved along the object W. However, when printing is performed on the object W at the ink ejection timing shown in FIG. 7, as shown in FIG. 10, the printing is performed in a shape in which the quadrangle P is planarly projected on the object W, and the quadrangle P will be distorted.

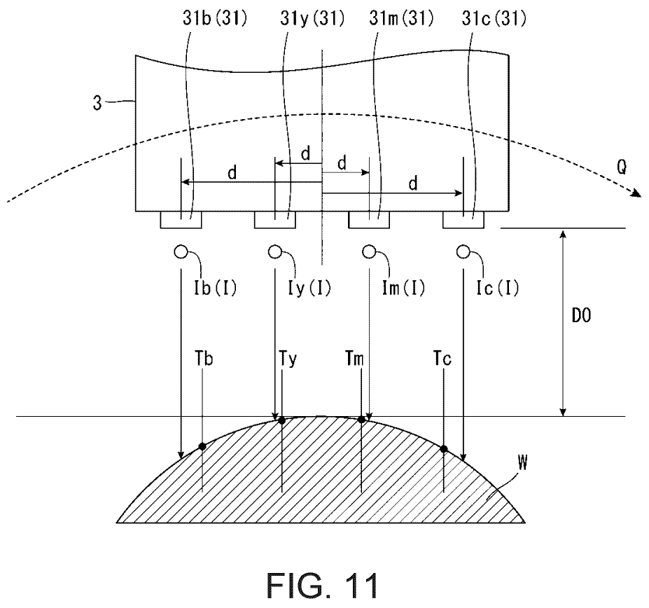

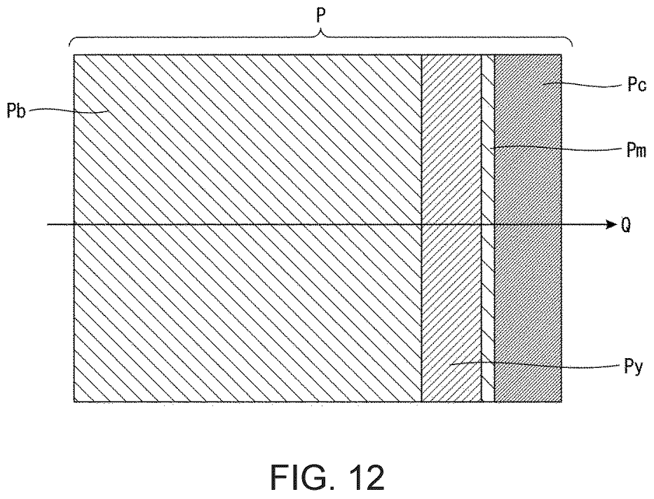

Specifically, as shown in FIG. 11, the landing position of the ink Im is shifted to the front side of the printing trajectory Q with respect to the target landing position Tm, the landing position of the ink Ic is significantly shifted to the front side of the printing trajectory Q with respect to the target landing position Tc, the landing position of the ink Iy is shifted to the rear side of the printing trajectory Q with respect to the target landing position Ty, and the landing position of the ink Ib is significantly shifted to the rear side of the printing trajectory Q with respect to the target landing position Tb. Therefore, as shown in FIG. 12, the quadrangles Pc, Pm, Py, and Pb formed by the inks Ic, Im, Iy, and Ib are formed to be shifted from each other along the printing trajectory Q. Therefore, misalignment, blurring, distortion, or the like occurs in the quadrangle P, and the printing quality deteriorates. In this case, this misalignment becomes larger as the radius of curvature of the target object W becomes smaller, and as the distance d of the nozzle 31 from the center of the print head 3 becomes larger. Such a factor that leads to deterioration of the printing quality is also referred to as a “first factor” hereinafter.

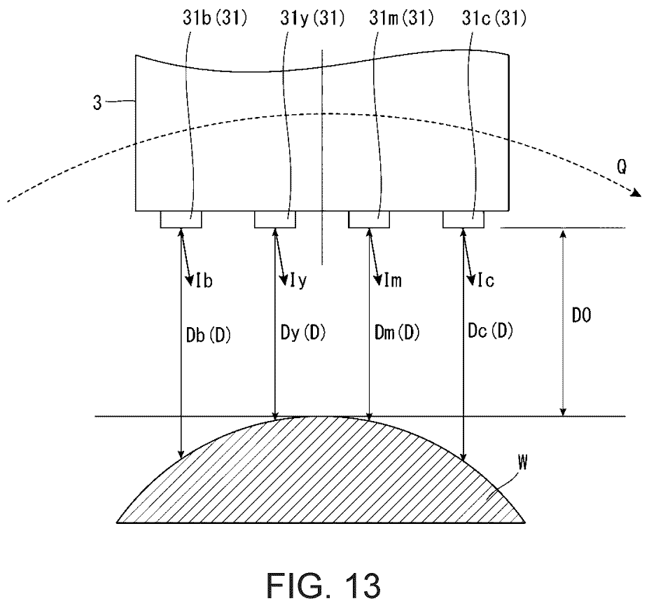

As shown in FIG. 13, when the moving distance between the nozzle 31 and the object W is D, specifically, the moving distance between the nozzle 31c and the object W is Dc, the moving distance between the nozzle 31m and the object W is Dm, the moving distance between the nozzle 31y and the object W is Dy, and the moving distance between the nozzle 31b and the object W is Db, the separation distances Dc and Db of the nozzles 31c and 31b located in the front row and the last row of the print trajectory Q are larger than the separation distances Dm and Dy of the nozzles 31m and 31y located in the center row of the print trajectory Q. In other words, the relationship is Dc=Db>Dm=Dy. In addition, since the nozzle 31c, nozzle 31m, nozzle 31y, and nozzle 31b are respectively arranged to be shifted from the center of the print head 3 to the front side or the rear side of the printing trajectory Q, the separation distances Dc, Dm, Dy, and Db are each larger than the ideal distances D0.

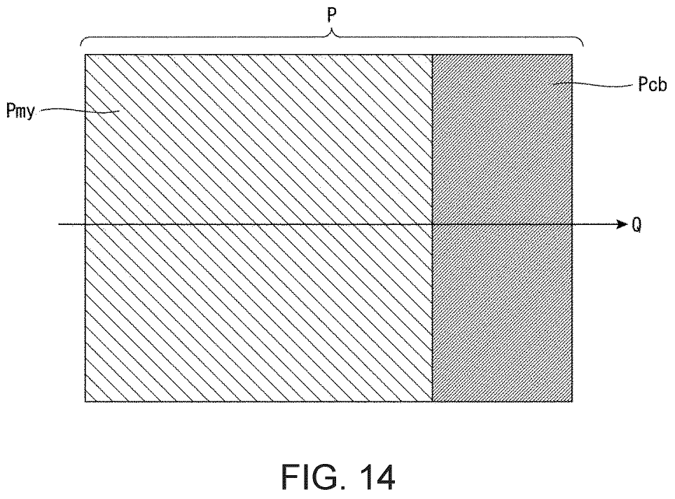

The larger the separation distance D, the longer the time from when the ink Ic, Im, Iy, or Ib is ejected to when the ink lands on the object W (hereinafter, also referred to as “flight time”). As shown in FIG. 13, since the inks Ic, Im, Iy, and Ib fly in a state of having a velocity component in the movement direction of the print head 3, the actual landing points of the inks Ic, Im, Iy, and Ib shift to the front side of the printing trajectory Q with respect to the target landing positions Tc, Tm, Ty, and Tb as the flight time becomes longer. Therefore, when printing is performed at the ink ejection timing shown in FIG. 7, as shown in FIG. 14, the quadrangle Pcb formed by the inks Ic and Ib shifts to the front side of the printing trajectory Q with respect to the quadrangle Pmy formed by the inks Im and Iy. As a result, misalignment, blurring, distortion, and the like occur in printing, and the printing quality deteriorates. Such a factor that leads to deterioration of the print quality is also referred to as a “second factor” hereinafter.

It is an object of the printing method of the present embodiment to eliminate deterioration of the printing quality due to the first factor and the second factor and to improve the printing quality. In the printing method of the present embodiment, by controlling the ejection timing of the inks Ic, Im, Iy, and Ib from the nozzles 31c, 31m, 31y, and 31b based on the separation distances Dc, Dm, Dy, and Db, it is possible to cause the inks Ic, Im, Iy, and Ib to accurately land on the target landing positions without being influenced by the first factor and the second factor. Specifically, in the printing method of the present embodiment, as the separation distances Dc, Dm, Dy, and Db become larger, the ejection timings of the inks Ic, Im, Iy, and Ib are made earlier, it is possible to cause the inks Ic, Im, Iy, and Ib to accurately land on the target landing positions without being influenced by the first factor and the second factor. That is, it is possible to further suppress the misalignment of the actual landing position from the target landing position. As a result, misalignment, blurring, distortion, and the like are less likely to occur in printing, and the printing quality can be improved.

Hereinafter, the driving condition determination step S1 and the printing step S2 of the printing method of the present embodiment will be described in detail.

### Driving Condition Determination Step S1

In the driving condition determination step S1, first, the control device 9 acquires various kinds of information necessary for determining the driving conditions of the print head 3. In the present embodiment, information of the print head 3, specifically, the position of each nozzle 31 and the ejection speed of the ink I are set in advance in the control device 9. The control device 9 receives various other necessary information from the user via, for example, a graphic user interface (GUI) shown in FIG. 15. The GUI has a print setting field G1, a shape reading field G2, and a print range designation field G3.

The control device 9 receives a print image to be printed on the object W and a moving speed (print scan speed) of the print head 3 from the user in the print setting field G1. The user presses the “select” button to select the desired image stored in the computer. The control device 9 accepts an image selected by the user as a print image. Here, it will be assumed that the quadrangle P shown in FIG. 6 is selected. By inputting a desired numerical value in the field of the print scan speed, the user can designate the numerical value as the print scan speed.

The control device 9 receives the shape data of the object W from the user in the shape reading field G2. The user presses a “select” button to select desired shape data stored in a computer, a server, or the like. The control device 9 accepts the shape data specified by the user as the shape data of the object W. The shape data is not particularly limited, and examples thereof include CAD (computer aided design) data of the object W, and measurement data obtained by measuring the object W using a measuring device such as a 3D scanner. For example, in a case where the object W has a simple shape such as a planar shape or an arc shape having a constant curvature, the control device 9 can also receive the shape data of the object W by input of a numerical value from the user. In the present embodiment, CAD data is used as the shape data of the object W. By this, since accurate shape data is obtained, it is possible to accurately and easily calculate the printing trajectory Q and the separation distance D.

The control device 9 displays the shape of the object W in the print range designation field G3, and receives a print start point from the user. The user can designate the printing start point by inputting a desired numerical value in the column of the start position. The user can designate the printing start position by dragging and moving a broken line indicating the printing start position.

As described above, the control device 9 acquires various kinds of information necessary for determining the driving conditions of the print head 3. However, a method of acquiring these various kinds of information is not particularly limited. The configuration of the GUI, the type of information received by the GUI, and the like are not particularly limited.

Next, the control device 9 determines the printing trajectory Q for printing the quadrangle P at the designated position of the object W based on the various kinds of information received from the user. The printing trajectory Q is automatically generated by the control device 9 without receiving an instruction from the user. The printing trajectory Q includes information necessary for a printing operation, such as the position and posture, the moving direction and the moving speed of the print head 3 with respect to the object W in each control cycle. Further, the control device 9 calculates the separation distance D between each nozzle 31 and the object W based on the shape data of the object W, the printing trajectory Q, and the information of the print head 3. The separation distance D includes a separation distance Dc between each nozzle 31c and the object W, a separation distance Dm between each nozzle 31m and the object W, a separation distance Dy between each nozzle 31y and the object W, and a separation distance Db between each nozzle 31b and the object W. In the case of the present embodiment, the separation distances Dc of the nozzles 31c are equal to each other, the separation distances Dm of the nozzles 31m are equal to each other, the separation distances Dy of the nozzles 31y are equal to each other, and the separation distances Db of the nozzles 31b are equal to each other.

Next, the ink ejection timing for each nozzle 31 is determined. In the present embodiment, the ink ejection timing for each nozzle 31 is determined by correcting the ink ejection timing shown in FIG. 7. In this case, for example, by using the relationships shown in FIGS. 16 and 18, it is possible to accurately and easily correct the ink ejection timing.

FIG. 16 is a graph showing the relationship between the radius of curvature R of the object W and the deviation amount of the actual landing position with respect to the target landing position of the ink I, and is suitably used to cancel the influence of the first factor. This relationship can be calculated from the position of each nozzle 31, the shape of the object W, the movement speed of the print head 3, the ejection speed of the ink I, and the like.

From this graph, it can be seen that, for example, when the radius of curvature of the object W is 50 mm, if printing is performed at the ink ejection timing shown in FIG. 7, then due to the influence of the first factor, the actual landing position of the ink Ic ejected from each nozzle 31c is shifted 120 μm forward from the target landing position, the actual landing position of the ink Im ejected from each nozzle 31m is shifted 5 μm forward from the target landing position, the actual landing position of the ink Iy ejected from each nozzle 31y is shifted 5 μm backward from the target landing position, and the actual landing position of the ink Ib ejected from each nozzle 31b is shifted from the target landing position to 120 μm backward from the target landing position.

Further, when the moving speed of the print head 3 is 127 mm/s, then in order to cancel the above-described misalignment and land the inks Ic, Im, Iy, and Ib at the target landing positions, then as shown in FIG. 17, the ejection timing of each ink Ic should be advanced by (120 μm)/(127 mm/s)=0.94 ms, the ejection timing of each ink Im should be advanced by (5 μm)/(127 mm/s)=0.04 ms, the ejection timing of each ink Iy should be delayed by (5 μm)/(127 mm/s)=0.04 ms, and the ejection timing of each ink Ib should be delayed by (120 μm)/(127 mm/s)=0.94 ms with respect to the ink ejection timing shown in FIG. 7. By this, the influence of the first factor is cancelled, and it is possible to perform high-quality printing with little misalignment, blurring, distortion, and the like.

FIG. 18 is a graph showing the relationship between the radius of curvature R of the object W and the misalignment amount of the landing position between the nozzles 31c, 31m, 31y, and 31b, and is used to cancel the influence of the second factor. This relationship can be calculated from the position of each nozzle 31, the shape of the object W, the movement speed of the print head 3, the ejection speed of the ink I, and the like.

For example, when the radius of curvature of the object W is 50 mm and the moving speed of the print head 3 is 127 mm/s, it can be seen that the inks Ic and Ib will land 85 μm ahead of the inks Im and Iy. Therefore, in order to cancel this misalignment, as shown in FIG. 19, the ejection timings of the inks Ic and Ib should be made earlier than the ejection timings of the inks Im and Iy by (85 μm)/(127 mm/s)=0.67 ms with respect to the corrected ink ejection timings shown in FIG. 17. By this, the influence of the second factor is cancelled, and it is possible to perform high-quality printing with little misalignment, blurring, distortion, and the like.

As described above, the driving conditions of the print head 3 shown in FIG. 20 are determined. Thus, by correcting the ink ejection timing shown in FIG. 7 using the relationship shown in FIGS. 16 and 18, it is possible to effectively cancel the misalignment of the landing position due to the first factor and the second factor, and it is possible to land each ink I on the target landing position. In the present embodiment, the ink ejection timing shown in FIG. 7 is set as the initial setting, and the driving conditions of the print head 3 are determined by correcting this setting using the relationships shown in FIGS. 16 and 18, but the method of determining the drive conditions is not particularly limited. For example, the driving conditions of the print head 3 shown in FIG. 20 may be determined using the relationship shown in FIGS. 16 and 18 instead of using the initial setting shown in FIG. 7.

### Printing Step S2

In the printing step S2, the control device 9 performs the printing operation by controlling the drive of the print head 3 based on the driving condition (ink ejection timing) of the print head 3 shown in FIG. 20 determined in the driving condition determination step S1 while driving the robot arm 22 to move the print head 3 along the printing trajectory Q. By this, a high-quality quadrangle P is printed on the object W with little misalignment, blurring, distortion, and the like. In the printing step S2, during the printing operation, vibration of the print head 3 is detected based on the output of the vibration meter 5, and the driving of the moving stage 4 is controlled so that the detected vibration is canceled. Specifically, the driving of the moving stage 4 is controlled so that vibration having the opposite phase to the detected vibration is applied to the print head 3. This suppresses vibration of the print head 3 during the printing step S2, and higher quality printing can be performed.

The robot system 1 has been described above. As described above, the printing method using the robot system 1 is performing a printing operation on the object W by ejecting the ink I from the nozzle 31 while relatively moving the object W and the print head 3 along the printing trajectory Q by using the robot 10 including the print head 3 in which the plurality of nozzles 31 are disposed, and controlling the timing of ejecting the ink I from the nozzle 31 based on the separation distance D between the nozzle 31 and the object W.

According to such a method, even when the shape of the object W is a curved surface or a bent surface other than a flat surface, it is possible to perform high-quality printing on the object W with little misalignment, blurring, distortion, and the like.

As described above, in the printing method using the robot system 1, the above-described control is performed for each nozzle 31.

That is, the timing of ejecting the ink I is controlled for each nozzle 31.

By this, it is possible to perform high-quality printing on the object W with little misalignment, blurring, distortion, and the like.

As described above, in the printing method using the robot system 1, the ejection timing of the ink I is made earlier as the separation distance D is larger.

By this, it is possible to reduce the misalignment of the actual landing position with respect to the target landing position of the ink I. Therefore, it is possible to perform high-quality printing on the object W with little misalignment, blurring, distortion, and the like.

As described above, in the printing method using the robot system 1, the separation distance D is calculated using CAD data of the object W.

By this, the separation distance D can be calculated accurately and easily.

As described above, a plurality of nozzles 31 is disposed along the printing trajectory Q.

Specifically, the nozzles 31c, 31m, 31y, and 31b are disposed along the printing trajectory Q.

Therefore, when printing is performed on the non-planar object W, the separation distance D varies between the nozzle 31c, 31m, 31y, and 31b. Therefore, the effect of the above-described control can be more remarkably exhibited.

As described above, the inks Ic, Im, Iy, and Ib of different colors are ejected from the respective nozzles 31c, 31m, 31y, and 31b.

By this, multi-color printing, particularly full-color printing can be performed.

As described above, the robot system 1 includes the robot 10 including the print head 3 in which a plurality of nozzle 31 are disposed, and the control device 9 that controls the driving of the robot 10. The control device 9 performs a printing operation on the object W by ejecting the ink I from the nozzles 31 while relatively moving the object W and the print head 3 along the printing trajectory Q, and during printing operation, controls the timing of ejecting the ink I from the nozzles 31 based on the separation distance D between the nozzles 31 and the object W.

According to such a configuration, even when the shape of the object W is a curved surface or a bent surface other than a flat surface, it is possible to perform high-quality printing on the object W with little misalignment, blurring, distortion, and the like.

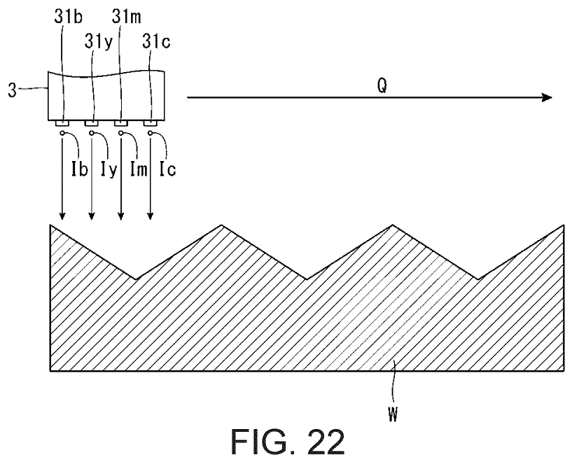

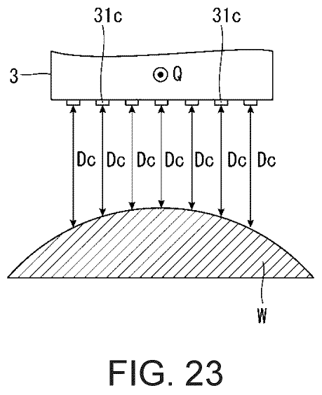

The printing method of the present embodiment has been described above. However, the printing method is not particularly limited. For example, the shape of the object W is not particularly limited, and may be a wavy concavo-convex shape as those shown in FIGS. 21 and 22. In this case, since the separation distances Dc, Dm, Dy, and Db repeatedly increase and decrease during the printing step S2, the ink ejection timing should be corrected accordingly. Further, as shown in FIG. 23, it may have a curved shape when viewed from the direction along the printing trajectory Q. In this case, since the separation distance Dc is different for each nozzle 31c, the ink ejection timing should be corrected for each nozzle 31c. The same applies to the other nozzles 31m, 31y, and 31b.

### Second Embodiment

The present embodiment is the same as the above-described first embodiment except that the driving condition determination step S1 of the printing method is different. In the following description, the present embodiment will be described focusing on differences from the first embodiment described above, and the description of the same matters will be omitted. In each drawing of the present embodiment, the same reference numerals are given to the same configurations as those of the above-described embodiment.

In the first embodiment described above, in order to cancel the influence of the second factor, the ejection timing of the ink I shown in FIG. 17 is corrected as shown in FIG. 19. On the other hand, in the present embodiment, in order to cancel the influence of the second factor, the ejection speed of the ink I is corrected with respect to the ink ejection timing shown in FIG. 17. Specifically, by increasing the ejection speed of the inks Ic, Im, Iy, and Ib as the separation distances Dc, Dm, Dy, and Db increase, the inks Ic, Im, Iy, and Ib can be accurately deposited at the target landing positions without being influenced by the second factor. That is, it is possible to further suppress the misalignment of the actual landing position from the target landing position. As a result, misalignment, blurring, distortion, and the like are less likely to occur in printing, and the printing quality can be improved. In the present embodiment, the ejection speed of the inks Ic and Ib is increased so that the flying time of the inks Ic and Ib is shorter than the flying time of the inks Im and Iy by 0.67 ms. By this, the influence of the second factor is cancelled, and it is possible to perform high-quality printing with little misalignment, blurring, distortion, and the like.

The method of changing the ejection speed of the ink I is not particularly limited. For example, the print head 3 is the ink jet head of the piezo drive system, and the ink I in the ink chamber is ejected from the nozzle 31 by vibrating the diaphragm by applying a voltage to the piezoelectric element to vibrate the piezoelectric element. At this time, as the voltage applied to the piezoelectric element increases, the diaphragm vibrates more, and the ink I is ejected at a higher speed. Therefore, by making use of such characteristics, in the present embodiment, the ejection speed of the inks Ic and Ib is increased by increasing the voltage applied to the piezoelectric element for vibrating the vibrating plate disposed in the ink chambers of the inks Ic and Ib with respect to the initial condition. According to such a method, the influence of the second factor can be canceled by simple control.

As described above, the printing method using the robot system 1 is performing a printing operation on the object W by ejecting the ink I from the nozzle 31 while relatively moving the object W and the print head 3 along the printing trajectory Q by using the robot 10 including the print head 3 in which the plurality of nozzles 31 are disposed, and controlling the ejection speed of the ink I from the nozzle 31 based on the separation distance D between the nozzle 31 and the object W. According to this method, it is possible to cancel the influence of the second factor, and even if the shape of the object W is a curved surface or a bent surface other than a plane, it is possible to perform high-quality printing on the object W with less misalignment, blurring, distortion, and the like.

As described above, in the printing method using the robot system 1, the larger the separation distance D, the faster the ejection speed. By this, it is possible to reduce the misalignment of the actual landing position with respect to the target landing position of the ink I. Therefore, it is possible to perform high-quality printing on the object W with little misalignment, blurring, distortion, and the like.

As described above, the robot system 1 includes the robot 10 including the print head 3 in which a plurality of nozzle 31 are disposed, and the control device 9 that controls the driving of the robot 10. Also, the control device 9 performs a printing operation on the object W by ejecting the ink I from the nozzle 31 while relatively moving the object W and the print head 3 along the printing trajectory Q, and controls the ejection speed of the ink I based on the separation distance D between the nozzle 31 and the object W in the printing operation. According to such a configuration, it is possible to cancel the influence of the second factor, and even when the shape of the object W is a curved surface or a bent surface other than a flat surface, it is possible to perform high-quality printing on the object W with little misalignment, blurring, distortion, and the like.

According to the second embodiment, the same effects as those of the first embodiment described above can be obtained.

Note that, in the present embodiment, the correction of the ink ejection timing is used for canceling the first factor and the correction of the ejection speed of the ink is used for canceling the second factor, but the present disclosure is not limited to this. For example, the correction of the ejection speed of the ink may be used to cancel the first factor, and the correction of the ink ejection timing may be used to cancel the second factor. The correction of the ejection speed of the ink may be used for both the cancellation of the first factor and the cancellation of the second factor. The same effects can be achieved by such methods.

### Third Embodiment

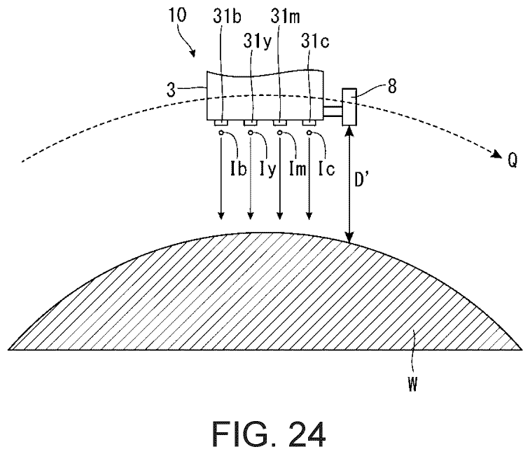

FIG. 24 is a diagram showing a configuration of a distal end portion of a robot included in a robot system according to a third embodiment.

The present embodiment is the same as the above-described first embodiment except that the printing method is different. In the following description, the present embodiment will be described focusing on differences from the first embodiment described above, and the description of the same matters will be omitted. In the drawings of the present embodiment, the same components as those of the above-described embodiment are denoted by the same reference numerals.

In the first embodiment described above, the driving condition determination step S1 for determining the driving condition of the print head 3 is performed prior to the printing step S2, but in the present embodiment, the driving condition of the print head 3 is corrected during the printing step S2. According to such a method, the time required for the driving condition determination step S1 can be omitted, and the efficiency of the printing operation can be improved.

As shown in FIG. 24, the robot 10 of the present embodiment includes a distance sensor 8 that is disposed in the print head 3 and that measures the separation distance D′ from the object W. The distance sensor 8 is positioned during the printing step S2 at the front side of the printing trajectory Q with respect to the print head 3. During movement of the print head 3 in the printing step S2, the control device 9 measures the separation distance D′ between the position in front of the print head 3 and the object W using the distance sensor 8. Further, based on the separation distance D′, the control device 9 calculates the separation distances Dc, Dm, Dy, and Db when the nozzles 31c, 31m, 31y, and 31b are directly facing the position. Then, the control device 9 corrects the ejection timing or the ejection speed of the ink I so that it lands on the place based on the calculated separation distances Dc, Dm, Dy, and Db, and controls the driving of the print head 3 under the corrected driving condition. By repeatedly performing such a correction operation at a predetermined cycle during the movement of the print head 3, it is possible to generate the driving conditions as shown in FIG. 20 while performing printing. Therefore, even if the driving conditions of the print head 3 are not determined in advance, it is possible to perform high-quality printing on the object W with little misalignment, blurring, distortion, and the like.

In the printing method as described above, the separation distance D′ is calculated while the printing operation is performed by using the distance sensor 8 for measuring the separation distance D′. According to such a method, the efficiency of the printing operation can be improved.

The third embodiment can also achieve the same effects as the first embodiment described above.

While the printing method and the robot system of the present disclosure have been described with reference to the illustrated embodiments, the present disclosure is not limited to these, and the configurations or processes of the respective parts can be replaced with arbitrary configurations or processes having similar functions. Other arbitrary components or processes may be added to the present disclosure. The embodiments may be appropriately combined.

1. A printing method comprising:
performing a printing operation on an object by ejecting ink from nozzles while relatively moving the object and a print head along a printing trajectory by using a robot including the print head in which the plurality of nozzles are disposed and
controlling a timing of ejecting the ink from the nozzle or an ejection speed of the ink based on a separation distance between the nozzle and the object.

2. The printing method according to claim 1, wherein
the control is performed for each of the nozzles.

3. The printing method according to claim 1, wherein
the larger the separation distance, the earlier that the timing is set.

4. The printing method according to claim 1, wherein
the larger the separation distance, the faster that the ejection speed is set.

5. The printing method according to claim 1, wherein
the separation distance is calculated using CAD data of the object.

6. The printing method according to claim 1, wherein
the separation distance is calculated while performing the printing operation using a distance sensor that measures the separation distance.

7. The printing method according to claim 1, wherein
the plurality of nozzles are disposed along the printing trajectory.

8. The printing method according to claim 7, wherein
inks of different colors are ejected from the plurality of nozzles.

9. A robot system comprising:
a robot provided with a print head in which a plurality of nozzles are disposed and
a control device configured to control drive of the robot, wherein
the control device performs a printing operation on the object by ejecting ink from the nozzles while relatively moving the object and the print head along a printing trajectory and
in the printing operation, controls timing of ejecting ink from the nozzles or an ejection speed of the ink based on a separation distance between the nozzles and the object.
